(19) United States
(12) Patent Application Publication
(10) Pub. No.: US 2024/0067504 A1
(43) Pub. Date: Feb. 29, 2024

(54) METHOD OF MONITORING ASSEMBLY OF AN ELEVATOR AND APPARATUS

(71) Applicant: Kone Corporation, Helsinki (FI)

(72) Inventors: Aki HAIKONEN, Helsinki (FI); Anssi VENHO, Helsinki (FI); Mika IJAS, Helsinki (FI); Jukka LAITINEN, Helsinki (FI); Ville MYYRYLAINEN, Helsinki (FI); Kai PRUSTI, Helsinki (FI)

(73) Assignee: Kone Corporation, Helsinki (FI)

(21) Appl. No.: 18/501,247

(22) Filed: Nov. 3, 2023

Related U.S. Application Data
(63) Continuation of application No. PCT/EP21/66468, filed on Jun. 17, 2021.

(51) Int. Cl. B66B 19/00; B66B 3/00; B66B 5/02; B66B 11/00

(52) U.S. Cl. CPC B66B 19/00; B66B 3/002; B66B 5/02; B66B 11/0005

(57) ABSTRACT

This invention relates to a method of monitoring assembly of an elevator, comprising prefabricating a plurality of hoistway sections each hoistway section having a hoistway space, transporting the hoistway sections to a building site, and lifting the hoistway sections at the building site on top of each other. In order to facilitate fast and reliable assembly, a hoistway section is provided during prefabrication with a sensor device having a transmitter which is activating during prefabrication to transmit sensor data via to a data storage storing the transmitted sensor data in a memory. The sensor data is monitored, and transmission of a message to a predetermined recipient is triggered when the sensor data fulfills at least one predetermined criterion defined in an assembly plan.

### CROSS-REFERENCE TO RELATED APPLICATION

This application is a continuation of PCT International Application No. PCT/EP2021/066468 which has an International filing date of Jun. 17, 2021, the entire contents of which are incorporated herein by reference.

### BACKGROUND OF THE INVENTION

### Field of the Invention

This invention relates to a method of monitoring assembly of an elevator and to an apparatus. More specifically, the invention relates to a solution ensuring that prefabricated hoistway sections are handled according to an assembly plan.

### Description of Prior Art

The building industry has in recent years taken into use new building techniques with the aim of speeding up and making the building process more efficient. These changes have also an impact on elevators, as it is necessary to come up with solutions suitable for use with modern building techniques.

One known solution is to construct an elevator in such a way, that the elevator hoistway includes a plurality of hoistway sections attached to each other to provide a hoistway with a hoistway space. An elevator car is arranged in the hoistway space to move vertically in the hoistway space between door openings at landings of the building.

The hoistway sections may in practice prefabricated as modules, possibly at another location than the building site of the building. These hoistway sections may be equipped with landing doors or other devices in such a way that once the hoistway sections are lifted on top of each other at the building site, it is as easy as possible to assemble the entire elevator hoistway from these prefabricated hoistway sections.

This way of constructing an elevator hoistway causes new challenges. It is necessary to ensure that the hoistway sections are transported and lifted at the correct moments, and to ensure that a hoistway section damaged during handling does not end up in the building.

### SUMMARY OF THE INVENTION

An object of the present invention is to solve the above-mentioned challenges. This object is achieved with a method according to independent claim 1 and an apparatus according to independent claim 8.

When the prefabricated hoistway section is during prefabrication provided with a sensor producing sensor data and a transmitter is activated to transmit the sensor data, monitoring of this hoistway section becomes possible in such a way that parties involved in the assembly of the elevator have the information needed to ensure successful assembly of the elevator.

Preferred embodiments of the invention are disclosed in the dependent claims.

### BRIEF DESCRIPTION OF DRAWINGS

In the following the present invention will be described in closer detail by way of example and with reference to the attached drawings, in which

FIGS. 1 and 2 illustrate an apparatus, and

FIG. 3 illustrates a method of monitoring assembly of an elevator.

### DESCRIPTION OF AT LEAST ONE EMBODIMENT

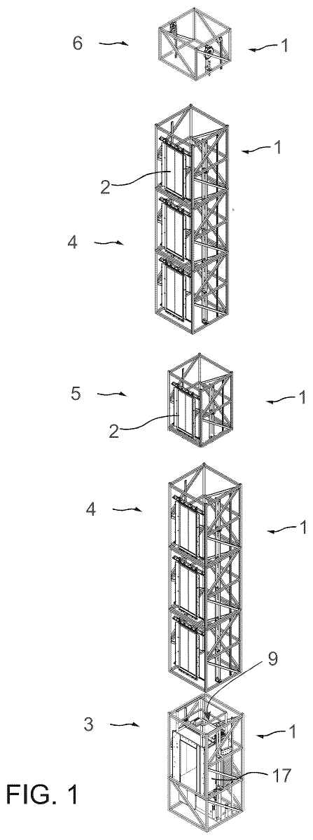

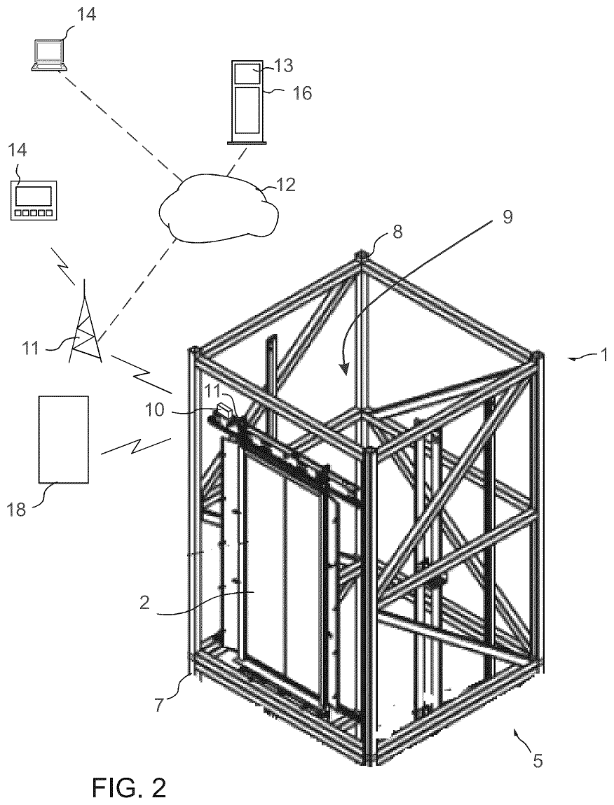

FIGS. 1 and 2 illustrate an apparatus. FIG. 1 illustrates prefabricated hoistway sections of an elevator hoistway, and FIG. 2 illustrates a detail of a hoistway section and a data storage.

The hoistway sections 1 of FIG. 1 may in practice be prefabricated as modules having a hoistway space 9 for an elevator car 17. Manufacturing can be implemented at another location than the building site of the building. These hoistway sections may be equipped with landing doors 2 and/or other devices in such a way, that once the hoistway sections are lifted on top of each other at the building site, it is as easy as possible to assemble the entire elevator hoistway from these prefabricated hoistway sections. Typically, the hoistway sections 1 may be manufactured of steel, for instance, such that each hoistway section 1 is capable of carrying the weight of the hoistway sections arranged on top of it.

As is clear from FIG. 1, the hoistway sections 1 are not all identical. Typically, at least the uppermost 6 and lowermost 3 hoistway sections are differently implemented than the intermediate hoistway sections 4 and 5. As illustrated in FIG. 1, the elevator car 17 may be preassembled into the lowermost hoistway section 3. In FIG. 1 it has also by way of example been assumed that in this implementation four different types of hoistway sections 3 to 6 are utilized. Due to this, the order in which the hoistway sections are lifted in place at the installation site is important.

In order to assemble a hoistway of the illustrated hoistway sections 3 to 6, an assembly plan is needed, which preferably defines the manufacturing order, the transport order and the lifting order of the hoistway sections 1. With such an assembly plan, it can be ensured that the elevator hoistway is assembled in the correct order to obtain a functioning elevator. The assembly plan may also contain information about the timing. In particularly, the manufacturing timing, the transport timing and the lifting timing should be pre-defined, to ensure that hoistway sections 1 are manufactured on time to minimize unnecessary storing at the building site or at other sites. Additionally, the assembly plan may contain information about how the hoistway sections should be handled. More particularly, the allowed acceleration (hits during handling) and limit values for humidity and temperature. Also information about parties involved may be defined in the assembly plan, which makes it possible to transmit messages to correct recipients when at least one criterion defined in the assembly plan is fulfilled. This makes it possible to keep the correct persons aware of the progress with the assembly of the elevator.

FIG. 2 illustrates a detail of the hoistway section 5 illustrated in FIG. 1 and a data storage 16. The hoistway section 5, similarly as all the other hoistway sections 1 of FIG. 1, has been premanufactured to have a hoistway space 9 for an elevator car and at least one of a lower attachment interface 7 and an upper attachment interface 8. The hoistway section 5 illustrated in FIG. 2 has both a lower 7 and an upper 8 attachment interface, as this hoistway section 5 is an intermediate section intended to be located between the uppermost and the lowermost elevator sections 3 and 6, due to which it is attached during assembly to the hoistway sections below it and above it via the lower 7 and upper 8 interface.

The hoistway section 5 is provided with a sensor device 10, which has a sensor producing sensor data and a transmitter. During prefabrication of the hoistway section, the sensor device 10 has been activated to transmit the sensor data. In the illustrated example the sensor device 10 is attached to a top rack 11, such as a beam, carrying the landing door 2 of the hoistway section 5, however, in other implementations the sensor device 10 may be located in some other part of the hoistway section.

The transmitter implemented in the sensor device 10 may be configured to transmit the sensor data wirelessly via base stations 11 of a communication system 12 from where the sensor data is forwarded to the data storage 16. The data storage 16 may be implemented as a server running a software which controls operation of the data storage 16 such that the received sensor data is stored in a memory 13. For simplicity, in FIG. 2 it is by way of example illustrated that the memory 13 is a part of the data storage 16, though in some implementations it may be a separate device from the data storage.

The data storage may also be implemented as a cloud service provided by a service provider. One alternative is to utilize sensor devices and a data storge provided by Sensolus, Rijsenbergstraat 148 D, 9000 Gent, Belgium, for instance.

In the illustrated example of FIG. 2, access to the sensor data stored in the data storage 16 is provided to terminals 14, which may be wired or wireless terminals capable of communicating with the data storage 16 via a wired or wireless communication path. In this way parties involved in assembly of the elevator from hoistway sections 1 are able via the terminals 14 to receive messages from the data storage 16 and to monitor the sensor data originating from the sensor device 10 of the hoistway section 5, and also from sensor devices of other hoistway sections. This makes it possible for the parties to ensure that assembly of the elevator is implemented on time and according to an assembly plan.

The sensor device 10 may include a positioning module, such as a module capable of determining the position of the hoistway section 5 based on GPS (Global Positioning System) signals. In that case the sensor device 10 includes the position of the hoistway section 5 in the produced sensor data. Due to this the parties involved may via the terminals 14 monitor the position of the hoistway section 5 after it has been premanufactured and while it is transported to the building site, and when it at the building site eventually is lifted to its final position in the hoistway.

Alternatively or in addition, the sensor device 10 may produce sensor data indicating at least one of humidity, temperature and acceleration. This makes it possible for the parties involved to monitor how the prefabricated hoistway section 5 is handled and stored during transport and storage before it is finally installed at the building site.

The data storage 16 receiving and storing the sensor data in the memory 13, may in some implementations maintain in the memory 13 also the assembly plan of the elevator which is assembled by utilizing the predefined hoistway sections 1. This makes it possible to configure the data storage 16, such as by a computer program, to monitor the transmitted sensor data and the assembly plan, and to trigger transmission of a message to a predetermined recipient when the sensor data fulfils at least one predetermined criterion defined in the assembly plan. Such a message may be an alarm if the sensor data transmitted from one or more prefabricated hoistway sections 5 deviates from one or more limit values set in the predefined assembly plan. An advantage of such a solution is that the parties involved in monitoring the assembly of the elevator can in that case automatically get an alarm such as an alarm message to their terminals 14, when assembly does not progress according to the assembly plan. Alternatively, the message can simply inform the recipient of progress in the assembly, such as informing a party involved that the hoistway section has arrived to a defined location, such as to the building site. In this way the parties involved can continuously automatically receive information about progress in the assembly, which makes it easier for the parties involved to time their own working tasks according to the actual progress, for instance.

Exactly when an alarm is triggered may vary between different implementations. One alternative is that the data storage 16 triggers an alarm if the sensor data indicates that the hoistway section is moved to a position which does not correspond to a position indicated in the assembly plan, for instance. In that case, a party responsible for the transportation of the hoistway section 5, may initially be aware of the fact that the hoistway section has been premanufactured and is ready for transportation to the building site, as the sensor device 10 is activated and the data storage initially receives and stores sensor data from this particular hoistway section 5. Subsequently, in case the hoistway section 5 is, according to the sensor data, transported to a position which does not correspond to the position of the building site, an alarm may be triggered by the data storage to the party responsible for transportation, for instance. Still another alternative is, that in case the sensor data indicates that the hoistway section 5 is transported to the building site in the wrong order or lifted at the building site to an incorrect position in the elevator hoistway, an alarm may be triggered.

Also timing of the transport of the hoistway section 5 is important, as delivery of the different hoistway sections 1 at the exactly planned moments of time makes the assembly of the elevator efficient, by avoiding unnecessary storage of the hoistway sections at intermediate locations between the transport path from the manufacturing site to their correct position in the elevator hoistway at the building site. Consequently, an alarm may be triggered in case the hoistway section is not transported or lifted into place during a time interval defined in the assembly plan. Due to the fact that monitoring of the location of the hoistway sections are possible in real time via the data storage 16 makes it easier for the parties involved in the elevator assembly to adjust their timing to obtain optimal delivery times and assembly times for the hoistway sections in the exactly correct order.

An alarm may be also be triggered if the data storage 16 detects that the sensor data indicates that at least one of the humidity, temperature or acceleration is out of a predetermined respective range defined in the assembly plan. In that case a party involved in the assembly may check the condition and quality of the hoistway section 5 prior to installation.

As an alternative to triggering an alarm, the data storage 16 may also be configured to trigger transmission of a message to a predetermined receiver when the position of a hoistway section 5 corresponds to a predefined location defined in the assembly plan. Such messages may be transmitted when the premanufacturing of the hoistway section 5 is completed (first sensor data received by data storage 16), when the hoistway section starts to move from the preassembly, when the hoistway section has reached the position of the building site, when the hoistway section is lifted at the building site and when the hoistway section 5 has reached its final position in the elevator hoistway. Due to such messages, a party or parties involved in the assembly of the elevator may get constant updates on the status of the hoistway section 5 to the terminals 14 they have available.

Once all the elevator hoistway sections 1 have been installed to the elevator hoistway, and the elevator car 17 and the elevator control 18 have been electrified, the elevator control 18 may start to receive the sensor data transmitted by the transmitter in the sensor device 10. The elevator control 18 may receive the sensor data directly from the sensor device 10 of each hoistway section 3 to 6, or alternatively, via the data storage 16, for instance.

The elevator control 18 does not need all sensor data which has been produced during the assembly of the elevator, which makes it possible to detach some sensors from the sensor device. However, sensor data indicating acceleration, for instance, is useful, as it indicates vibration in different parts of the hoistway during elevator runs. This sensor data together with sensor data produced by sensors in the elevator car can be utilized by the elevator control 18 to determine if vibrations are above limit values, such that an alarm should be triggered. In such a situation adjustment of rails or other devices may be beneficial to obtain a smooth run for the elevator car.

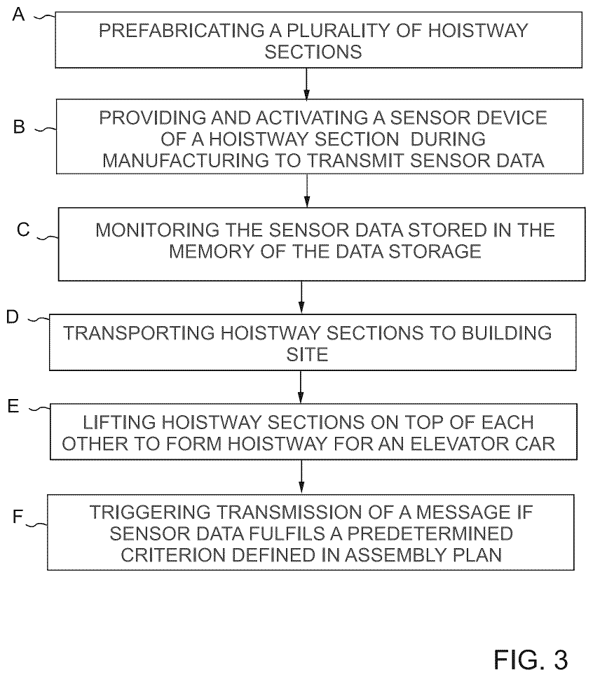

FIG. 3 illustrates a method of monitoring assembly of an elevator. The method of FIG. 3 can be utilized with the apparatus of FIGS. 1 and 2.

In step A, a plurality of hoistway sections 1 are prefabricated, each hoistway section having a hoistway space 9.

During prefabrication in step B, a sensor device 10 is provided to a hoistway section 5 and this sensor device is also during prefabrication activated to transmit sensor data via a communication system to a data storage 16. This makes it possible to monitor the sensor data stored in the memory of the data storge in step C. As a result, parties involved in assembly of the elevator can already after manufacturing of the hoistway section 5 via the data storage 16 detect that prefabrication of the hoistway section 5 has ended.

In step D the hoistway section 5 is transported to a building site, where the assembly of an elevator hoistway is carried out. Via sensor data including the position of the hoistway section 5, parties involved can determine that the different hoistway sections 3 to 6 are transported in the correct order and on time to the building site. Additionally, sensor data including the humidity, temperature and acceleration, makes it possible for parties involved in the assembly of the elevator hoistway to determine that the hoistway section is handled correctly during storage and transportation.

In step E the hoistway sections 1 are lifted on top of each other with hoistway spaces 9 aligned to form a hoistway for an elevator car 17. Via sensor data including the position of the hoistway sections 1, parties involved can determine that the different hoistway sections are lifted in position in the correct order, and on time according to an assembly plan. If a specific hoistway section 5 is lifted to early or too late as compared to other hoistway sections 3 and 4, this means that the hoistway section is being lifted to a position in the hoistway which does not correspond to the position according to the assembly plan.

In step F transmission of a message to a predetermined recipient is triggered if the sensor data fulfils at least one predetermined criterion defined in the assembly plan. The transmitted message may be an alarm message triggered when sensor data indicates that assembly of the elevator is not implemented according to the assembly plan. This triggering of alarm and the monitoring of step C can be automated, for instance in such a way the data storage in addition to the sensor data also stores the assembly plan in the memory. In that case the data storage may be configured to automatically monitor the sensor data, compare it to the assembly plan, and trigger transmission of an alarm to a predetermined involved party, in case the sensor data indicates that the sensor data indicates that the assembly is not done according to the assembly plan. Alternatively, the transmission of a message may be triggered when the position of the hoistway section corresponds to a predefined location defined in the assembly plan. In that case a party involved in assembly of the elevator may obtain information that the prefabricated hoistway has arrived to a specific location, such as to the building site or to its final location in the hoistway, for instance.

It is to be understood that the above description and the accompanying figures are only intended to illustrate the present invention. It will be obvious to a person skilled in the art that the invention can be varied and modified without departing from the scope of the invention.

1. A method of monitoring assembly of an elevator, comprising:
prefabricating a plurality of hoistway sections, each hoistway section having a hoistway space,
transporting the hoistway sections to a building site, and
lifting the hoistway sections at the building site on top of each other with the hoistway spaces aligned to form a hoistway for an elevator car, wherein
providing during said prefabrication a hoistway section with a sensor device having a sensor producing sensor data and a transmitter, and activating during prefabrication the transmitter of the hoistway section to transmit the sensor data via a communication system to a data storage storing the transmitted sensor data in a memory,
monitoring the sensor data stored in the memory of the data storage, and
triggering transmission of a message to a predetermined recipient when the sensor data fulfills at least one predetermined criterion defined in an assembly plan.

2. The method according to claim 1, comprising
providing during said prefabrication the hoistway section with a sensor device having a positioning module,
activating the transmitter of the hoistway section to transmit sensor data including a position of the hoistway section, and
triggering transmission of an alarm message if the monitored sensor data indicates that the position of the hoistway section at a specific moment does not correspond to a position indicated in the assembly plan.

3. The method according to claim 2, comprising triggering transmission of the alarm message if the sensor data indicates that the hoistway section is at the building site lifted to a position which does not correspond to a position indicated in the assembly plan.

4. The method according to claim 2, comprising triggering transmission of the alarm message if the sensor data indicates that the hoistway section is transported to the building site at a time which does not correspond to a time indicated in the assembly plan.

5. The method according to claim 2, comprising triggering transmission of the alarm message if the transmitter of the prefabricated hoistway section is activated at a time which does not correspond to a time indicated in the assembly plan.

6. The method according to claim 1, comprising
providing during said prefabrication the hoistway section with a sensor device producing sensor data indicating humidity, temperature and/or acceleration, and
triggering an alarm if the sensor data indicates that at least one of the humidity, temperature or acceleration is out of a predetermined respective range defined in the predetermined plan.

7. The method according to claim 1, wherein transmission of a message to the predetermined recipient is triggered when the position of the hoistway section corresponds to a predefined location defined in the assembly plan.

8. An apparatus, comprising:
a prefabricated hoistway section having a hoistway space for an elevator car, the hoistway section comprises at least one of a lower attachment interface and an upper attachment interface for attachment to a respective upper or lower hoistway section of an elevator hoistway, wherein
the hoistway section comprises a sensor device having a sensor producing sensor data and a transmitter which during prefabrication of the hoistway section has been activated to transmit the sensor data.

9. The apparatus according to claim 8, wherein the sensor device has a positioning module producing sensor data including a position of the hoistway section.

10. The apparatus according to claim 8, wherein the sensor device produces sensor data indicating at least one of humidity, temperature and acceleration.

11. The apparatus according to claim 8, wherein the apparatus comprises to a data storage receiving and storing the transmitted sensor data in a memory.

12. The apparatus according to claim 11, wherein
an assembly plan of an elevator is maintained in the memory, and
the data storage monitors the transmitted sensor data and the assembly plan and triggers an alarm if the sensor data transmitted from the prefabricated hoistway section deviates from one or more limit value set in the predefined assembly plan.

13. The apparatus according to claim 12, wherein the data storage triggers an alarm if the sensor data indicates that the hoistway section is moved to a position which does not correspond to a position indicated in the assembly plan.

14. The apparatus according to claim 12, wherein the data storage triggers an alarm if the sensor data indicates that at least one of the humidity, temperature or acceleration is out of a predetermined respective range defined in the assembly plan.

15. The apparatus according to claim 11, wherein an assembly plan of an elevator is maintained in the memory, and
the data storage monitors the transmitted sensor data and the assembly plan and triggers transmission of a message to a predetermined receiver when the position of a hoistway section corresponds to a predefined location defined in the assembly plan.

16. The apparatus according to claim 8, wherein the apparatus includes an elevator car and an elevator control receiving the sensor data when the elevator control and the elevator car have been electrified, the elevator control monitoring the operation of the elevator car by comparing the transmitted sensor data to one or more limit values, and triggers an alarm if the transmitted sensor data is not within a range set by the at least one or more limit values.
